(19) United States
(12) Patent Application Publication
(10) Pub. No.: US 2003/0172545 A1
(43) Pub. Date: Sep. 18, 2003

(54) Cleaning implement sanitizer

(76) Inventors: Marc L. Vitantonio, South Russell, OH (US); John R. Nottingham, Bratenahl, OH (US); John W. Spirk, Gates Mills, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/353,685

(22) Filed: Jan. 29, 2003

Related U.S. Application Data
(60) Provisional application No. 60/352,730, filed on Jan. 29, 2002.

(51) Int. Cl. F26B 19/00; F26B 25/06; F26B 3/34

(52) U.S. Cl. 34/266; 34/218

(57) ABSTRACT

A device for sanitizing moisture containing cleaning implements is provided and includes a first and second heatable plate, a hinge for moving the first heatable plate relative to the second heatable plate, and heating elements positioned with respect to the first and second heatable plates to provide heat to the first and second heatable plates respectively. During operation of the device the heatable plates are heated and steam is generated by the cleaning implement which acts to sanitize the heating implement.

### PRIORITY CLAIM

This application claims the benefit of U.S. provisional patent application Ser. No. 60/352,730 filed on Jan. 29, 2002 the entirety of which is hereby incorporated by reference.

### FIELD OF THE INVENTION

This invention generally relates to sanitizing devices and more specifically to devices which convert moisture upon a damp cleaning implement into steam which disinfects the cleaning implement.

### BACKGROUND OF THE INVENTION

Cleaning implements such as sponges and cloths are used to clean all over the house. These implements are used to clean any number of messes and as a result acquire and carry a large number of germs. Because these implements dry slowly or not at all, it is not uncommon for the germs within the implement to remain alive for long periods of time. These germs can be spread during subsequent uses of the implement. Traditional means of cleaning items in the house (i.e. the dishwasher or washing machine) are not typically used to clean these kinds of implements. The implements may contain the remains of harsh cleaning agents used in conjunction with the implement. These cleaning agents may damage, discolor or contaminate other household products if both are cleaned at the same time. On the other hand, there are typically not enough cleaning implements requiring sanitization at one time to justify running a dishwasher or washing machine load dedicated just to cleaning implements. Further, dishwashers and washing machines typically do not reach temperatures which are sufficient to kill all germs on a cleaning implement and, thus, are ineffective if not utilizing appropriate sanitizing chemicals.

The result of the inconvenience in sanitizing these cleaning implements is that the implements are often used in a contaminated state or discarded before their useful life is complete. A safe, simple, inexpensive, and effective method to destroy germs and bacteria upon cleaning implements is desired. Further, a small, inexpensive device, which can be safely used in the home is desired.

### SUMMARY OF THE INVENTION

The present invention overcomes disadvantages of the prior art by providing a small, efficient and affordable sanitizing device. The device may perform a cycle sanitizing a single, or small number of cleaning implements therein. The invention provides in one aspect, a device for sanitizing moisture containing cleaning implements including a first heatable plate, a second heatable plate, a hinge for moving said first heatable plate relative to said second heatable plate, and heating elements positioned with respect to said first and second heatable plates to provide heat to said first and second heatable plates respectively. During operation of the device steam is generated by the damp cleaning implement which acts to sanitize the cleaning implement.

No additional cleaning agents need to be added to the cleaning implement or the device provide efficient sanitizing of the cleaning implement. The device allows cleaning implements to be sanitized easily and repeatedly therefore resulting in fewer instances where cleaning implements are discarded prior to the end of their useful life.

### BRIEF DESCRIPTION OF THE FIGURES

FIG. 1 is a perspective view of the sanitizer including a sponge therein;

FIG. 2 is an exploded view of the sanitizer;

FIG. 3 is a close up perspective view of an alternate embodiment of a floating hinge upon the sanitizer;

FIG. 4 is an exploded view of an alternate embodiment of the sanitizer;

FIG. 5 is a front view of an alternate embodiment of the sanitizer;

FIG. 6 is a sectional view of the an alternate embodiment of the sanitizer; and

FIG. 7 is a sectional view of another embodiment of the sanitizer.

### DETAILED DESCRIPTION OF PREFERRED AND ALTERNATE EMBODIMENTS

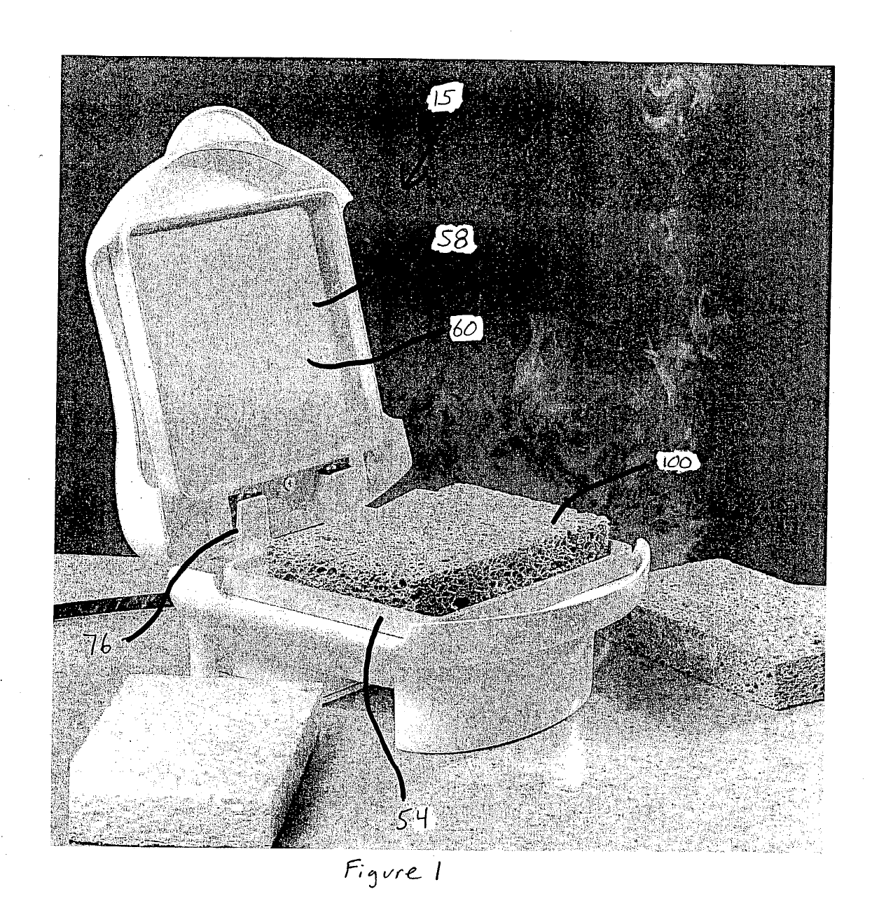

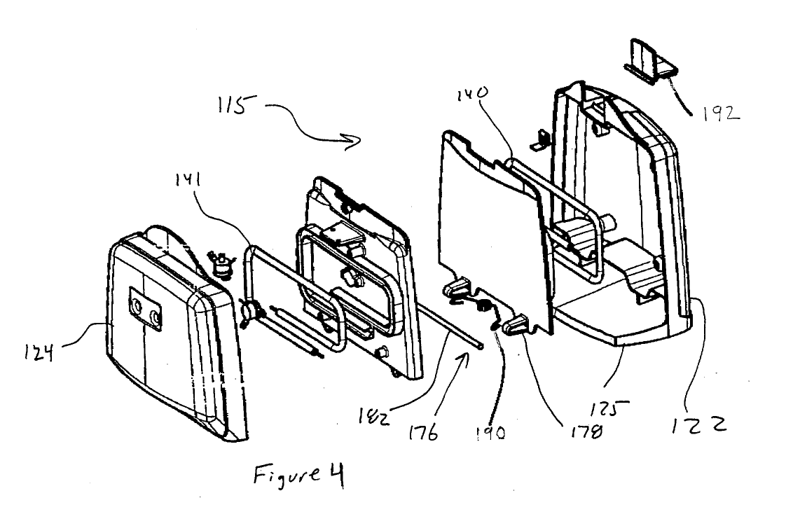

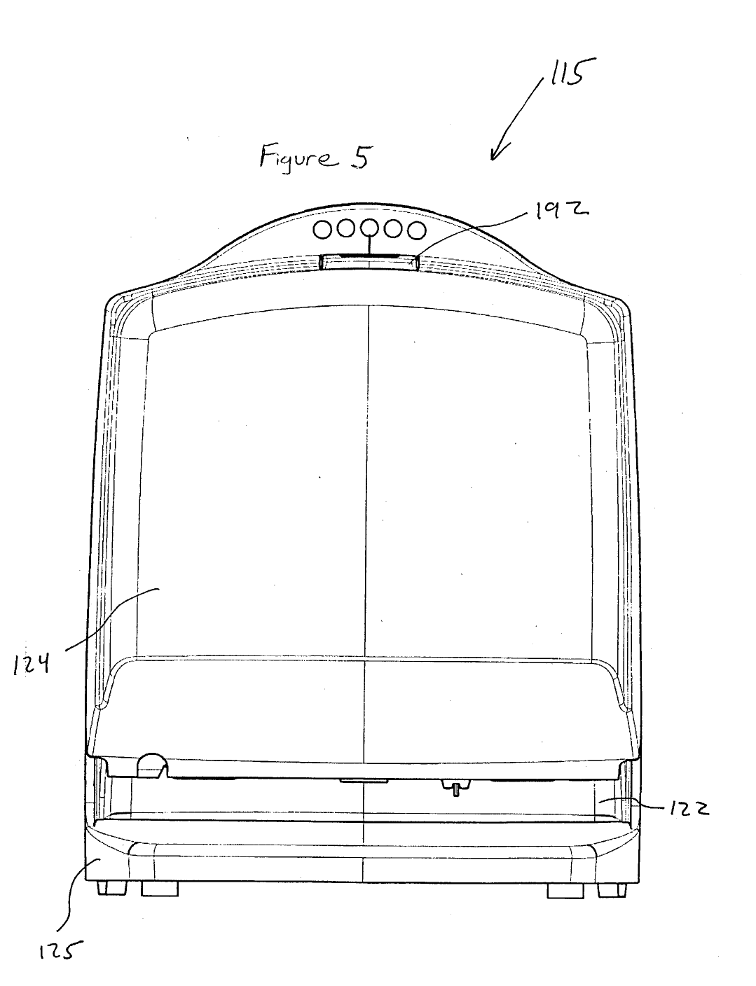

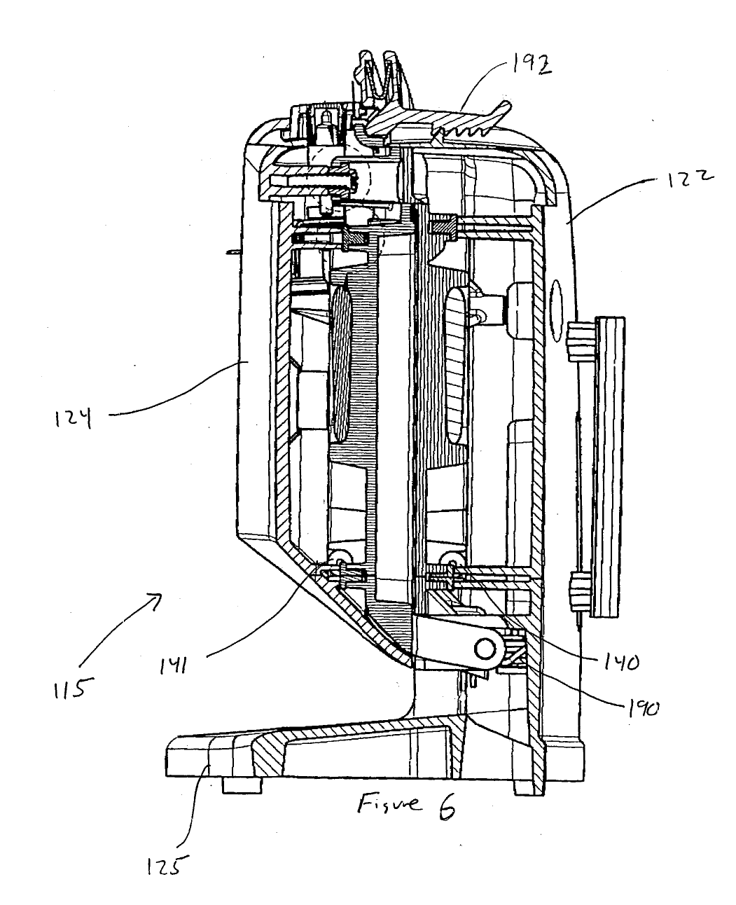

Referring to the drawings, FIG. 1 illustrates a preferred cleaning implement sanitizer 15 according to the invention. The cleaning implement sanitizer 15 may be used to sanitize implements 100 such a cloths, common sponges, nylon mesh encased foam pads, metallic scrub pads, foam sponges, sponges with scouring laminates and scouring pads. As described in more detail below, the cleaning implement sanitizer 15 comprises a first heatable plate 54 and a second heatable plate 58 attached by a hinge 76. The cleaning implement sanitizer 15 may exist in multiple embodiments including a horizontal embodiment shown in FIGS. 1, 2 and 3 as well as vertical embodiments shown in FIGS. 4, 5, 6 and 7. The vertical embodiments include a torsion spring 190 and closure 192 to allow the cleaning implement sanitizer 115 to remain fully closed during operation. Additional torsion springs 190 and 191 may be included to provide a smooth opening action in the cleaning implement sanitizer 15.

The cleaning implement sanitizer 15 utilizes heat to convert the moisture within a wet or damp cleaning implement 100 into steam. Certain types of germs and bacteria are destroyed by exposure to steam. Some types which may be destroyed are streptococcus groups A and B, hemopholis influenza, and streptococcus pneumonia and the germs which cause e-coli and salmonella. Moisture contained within the damp cleaning implements 100 is converted to steam and then may exit the cleaning implement sanitizer 15 through gaps between the heatable plates.

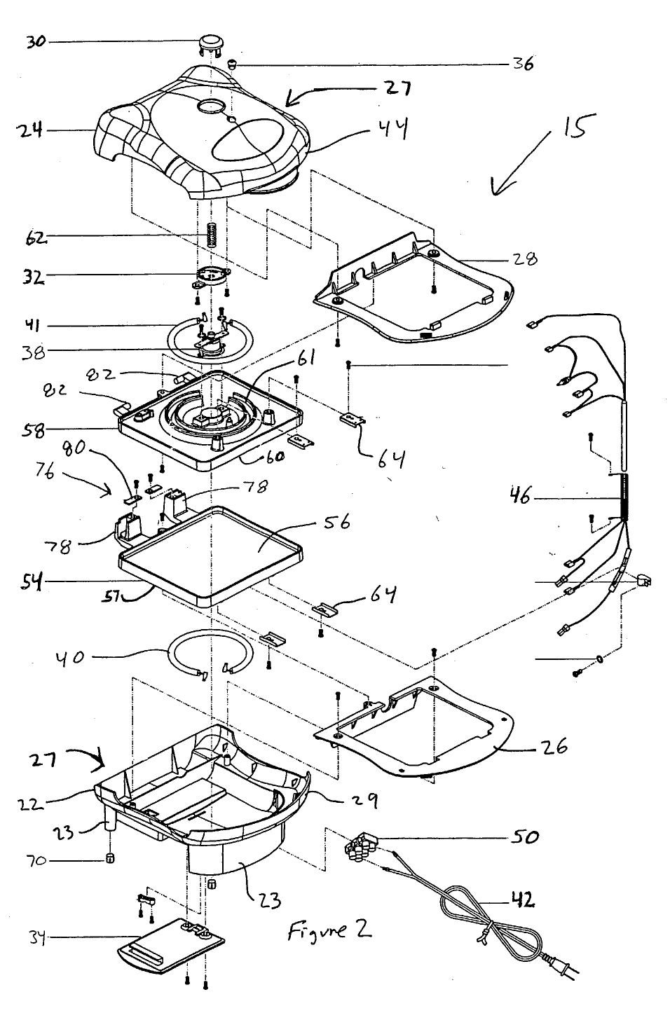

Referring to FIG. 2, the cleaning implement sanitizer 15 includes a first enclosure 22 and a second enclosure 24 which together form a device enclosure 27 which substantially forms the external surfaces of the cleaning implement sanitizer. The first enclosure 22 supports the first heatable plate 54. The first enclosure 22 houses a terminal 50 where power from an outside source is distributed within the cleaning implement sanitizer 15. The power may be provided by an 120 VAC, 60 Hz. outlet via a cord 42. The power may also be provided by batteries. The first enclosure 22 may include extensions 23 which operate as legs to support the cleaning implement sanitizer 15 upon a surface. The first enclosure 22 may also include a raised peripheral lip 29 which extends around the perimeter of the first enclosure. The lip 29 mates with a similar lip 44 upon a second enclosure 24. The lip's 29 and 44 height may vary around the perimeter of the enclosures 22 and 24. The lips 29 and 44 do not restrict the venting of steam from within the cleaning implement sanitizer 15 during operation. The first enclosure 22 supports a first enclosure cover 26. The first enclosure cover 26 includes an opening for passage of a heating element 40. The heating element 40 may be rated at any capacity sufficient for this purpose, but is preferably rated at 300 watts. The first enclosure cover 26 may be affixed to the first enclosure 22 with fasteners. The first heatable plate 54 may be affixed to the first enclosure cover 26. The first enclosure cover 26 includes notches which provide an attachment position for brackets 64 affixed to the first heatable plate 54.

The first heatable plate 54 may be of a rectangular shape or any other shape according to the majority of cleaning implements being sanitized. Such shapes include round or semi-circular. The plate 54 may be formed of any metallic material such as die cast aluminum, cast iron, stamped steel or copper. The first heatable plate 54 includes a first contact surface 56. The first contact surface 56 may have a shape which corresponds to the shape of the first heatable plate 54. The first contact surface 56 abuts the cleaning implement when the cleaning implement is placed within the cleaning implement sanitizer 15 and the sanitizer 15 is closed. The first heatable plate 54 may be heated and the heat is transferred via the first contact surface 56 to the cleaning implement. The first contact surface 56 is preferably flat and smooth, but may alternatively include slightly raised ribs. The first contact surface 56 may also include a non-stick coating. One such coating is polytetraflouroethylene. The first heatable plate 54 also defines two open ended barrels 78 which form a portion of a hinge 76. The first heatable plate 54 is supported by the first enclosure cover 26. In one embodiment of the invention, the first heatable plate 54 is in a horizontal orientation. Alternate orientations are described in more detail below.

A first seat 57 (not visible, but similar to second seat 61) may be defined by the first heatable plate 54 on an opposite side of the first contact surface 56. The first seat 57 is formed as part of the first heatable plate 54. Alternatively, the first seat 57 may be a separate piece affixed to the first heatable plate 54. The first seat 57 may comprise one or more raised protrusions. One protrusion may be in the shape of the first heating element 40 and may have a partial ring shape. However, heating elements and the first seat may be any shape. The first seat 57 functions to hold the first heating element 40 in place and provides an efficient heat transfer surface. The first seat 57 is smaller in size than the first heatable plate 54. Additional protrusions may be used to support brackets 64 used to affix the first heatable plate 54 to the first enclosure 22.

The second heatable plate 58 may be of a similar shape to the first heatable plate 54, preferably rectangular. The second heatable plate 58 is preferably made of the same material as the first heatable plate 54. The second heatable plate 58 functions to provide heat to an opposite side of the cleaning implement as it is held within the cleaning implement sanitizer 15. The second heatable plate 58 includes a second contact surface 60. The second contact surface 60 may also have a rectangular shape. The second contact surface 60 abuts the cleaning implement when the cleaning implement is placed within the cleaning implement sanitizer 15 and the sanitizer 15 is closed. The second heatable plate 58 may be heated and the heat is transferred via the second contact surface 60 to the cleaning implement. The second heatable plate 58 also defines two pins 82 which form a portion of the hinge 76. The second heatable plate 58 may be attached to the second enclosure cover 28. The second heatable plate 58, in a preferred embodiment, has a size which is the same as the first heatable plate 54. In one embodiment of the invention, the second heatable plate 58 is in a horizontal orientation. Alternate orientations are described in more detail below.

A second seat 61 may be defined by the second heatable plate 58 on an opposite side of the second contact surface 60. The second seat 61 is formed as part of the second heatable plate 58. Alternatively, the second seat 61 may be a separate piece affixed to the second heatable plate 58. The second seat 61 may comprise one or more raised protrusions. One protrusion may be in the shape of the second heating element 41. A second protrusion may be formed in a shape which mates to a thermostat shape to support a thermostat 38. The thermostat may be a manual reset type such as a type manufactured and sold under the name Therm-O-Dis. The second seat 61 functions to hold the second heating element 41 in place and provides an efficient heat transfer surface. The second seat 61 is smaller in size than the second heatable plate 58. Additional protrusions may be used to support brackets 64 used to affix the second heatable plate 58 to the second enclosure 44.

Heating elements 40 and 41 may have any shape, and are shown having a partial ring or “C” shape in FIG. 2. Heating elements may be of an electrical resistance type wherein electrical energy is transformed into heat energy. The heating element may be made of an iron-copper alloy. The heating elements 40 and 41 may have a rating of 300 watts each. The heating elements 40 and 41 are powered via wiring 46 from the terminal 50. In other embodiments of the invention the heating elements may have a different shape such as a rectangle.

A hinge 76 is used to secure the first heatable plate 54 and second heatable plate 58 together relative to one another, and to permit movement of one plate with respect to the other plate. The hinge 76 includes barrels 78 which hold pins 82. The hinge 76 may also include two hinge clamps 80 which hold the pins 82 within the barrels 78. The hinge clamps 80 are affixed to the open ended barrels 78. The barrels 78 are oversized to allow the pins 82 to “float” within. Such a “floating” hinge 76 of the type described allows the first heatable plate 54 and second heatable plate 58 to readily accommodate and close to surround cleaning implements of varying thicknesses while retaining the desired orientation between the plates 54 and 58. The hinge barrels 78 and pins 82, as stated above, are a part of the first heatable plate 54 and second heatable plate 58. These hinge components may be formed as part of the plates 54 and 58 or attached after the plates are formed. The hinge 76 is placed off of one edge of the heatable plates at a sufficient distance to allow the cleaning implement sanitizer 15 to close fully. The hinge 76 allows a gap between the heatable plates to vary between 1.25 centimeters and 2.5 centimeters as desired. Although the position of the barrels 78 has been described on the first heatable plate 54 and the pins 82 on the second heatable plate 58, these positions may be reversed.

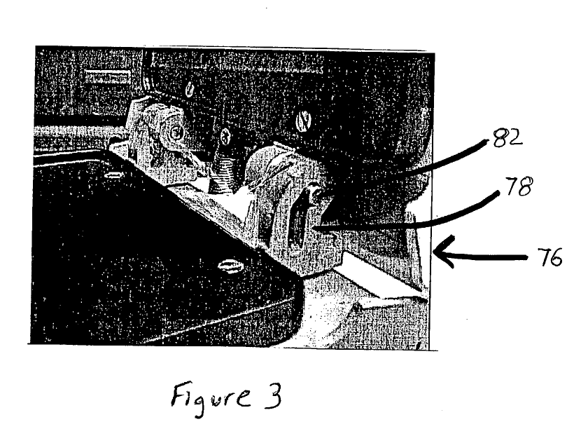

Referring to FIG. 3 an alternate embodiment of a hinge 76 is shown. In this embodiment the barrels 78 have closed ends and define angled openings within which the pins 82 may move.

The cleaning implement sanitizer 15 includes a second enclosure 24 which may be attached to the second heatable plate 58 via a second enclosure cover 28. The second enclosure 24 may be ornamentally contoured. The second enclosure 24 provides an ornamental top to the cleaning implement sanitizer 15 and provides a surface which is sufficiently insulated or heat resistant such that it may be touched and handled by the user during operation of the cleaning implement sanitizer 15. Alternatively, additional insulation material (not illustrated) may be provided internally of the first and second enclosures 22 and 24. The first and second enclosures 22 and 24 may be made from polymer materials which would resist the transfer of heat from the heatable plates, such materials are polypropylene, high temperature phenolic resins, polycarbonate, styrene or other thermoset polymer materials. The enclosures 22 and 24 and heatable plates 54 and 58 may be made from a substantially opaque material to prevent the cleaning implement from being exposed to light when the cleaning implement sanitizer is in a closed position. The second enclosure 24 also supports a pilot lamp lens 36 and push button 30 which are used to let the user interact with the cleaning implement sanitizer 15. In a preferred embodiment of the invention, the second enclosure 24 may be placed in a substantially vertical position when the cleaning implement sanitizer 15 is open, as in FIG. 1, and a substantially horizontal position when the cleaning implement sanitizer 15 is closed, as in FIG. 2. The second enclosure 24 may be attached to the second enclosure cover 28. The second enclosure cover 28 includes an opening for passage of a second heating element 41. The second enclosure cover 28 may be affixed to the second enclosure 24 with fasteners. The second heatable plate 58 may be affixed to the second enclosure cover 28.

The push button 30 may be any shape, but is disclosed in a round configuration. The push button 30 may be pushed to stop or start the operation of the cleaning implement sanitizer 15. The push button 30 is supported by a push button bracket 32 which is affixed to the second enclosure 24. A spring 62 may be placed between the push button 30 and a push button bracket 32, allowing the push button 30 to spring back to raised position after being pushed inwards. A pilot lamp lens 36 is supported by the second enclosure 24. The pilot lamp lens 36 covers a pilot lamp which indicates when the cleaning implement sanitizer 15 is heating. Wiring 46 is used on the interior of the cleaning implement sanitizer 15 to connect the heating elements 40, 41, theromstat 38 and terminal 50, as well as the push button and pilot lamp together electrically. A terminal cover 34 may be used to enclose the terminal 50. Rubber feet 70 may be affixed to extensions 23 from the first enclosure 22 to support the cleaning implement sanitizer 15 when in use. This embodiment may be stored in a vertical position.

The cleaning implement sanitizer 15 may be made in any size. Practically the width of the sanitizer at a maximum would be approximately 30 centimeters, at a minimum approximately 12.75 centimeters and preferably approximately 12.75 centimeters. The depth (horizontal embodiment) or height (vertical embodiment) at a maximum would be approximately 30 centimeters, at a minimum about 7.6 centimeters and preferably about 11.5 centimeters. A preferred depth (vertical embodiment) or height (horizontal embodiment) would be approximately 10.2 centimeters.

In another embodiment of the invention shown in FIGS. 4-6, the cleaning implement sanitizer 115 has a vertical, standing orientation. The first enclosure 122 and second enclosure 124 are in a substantially vertical position. The first enclosure 122 includes an extended leg 125 which functions as a base for the cleaning implement sanitizer 115. The first enclosure 122 may also have a generally rectangular shape which tapers, becoming more narrow from bottom to top. The first heating element 140 and second heating element 141 may be in a rectangular or overlapping rectangular form.

The hinge 176 includes barrels 178 in combination with an elongated pin 182 and a torsion spring 190. The torsion spring 190 acts to keep the first enclosure 122 and second enclosure 124 in position against each other in the absence of gravitational forces used in the horizontal embodiment of the cleaning implement sanitizer. A variable position closure 192 holds the first enclosure 122 and second enclosure 124 in position at the top of the cleaning implement sanitizer 115. The closure 192 includes multiple teeth which mate with teeth upon the first enclosure 122. Depending upon the thickness of the cleaning implement within the cleaning implement sanitizer 115, the two sets of teeth engage in different positions. The tails of the torsion spring 190 hook around the extended pin 182. The pin 182 is allowed to translate within the barrels 178.

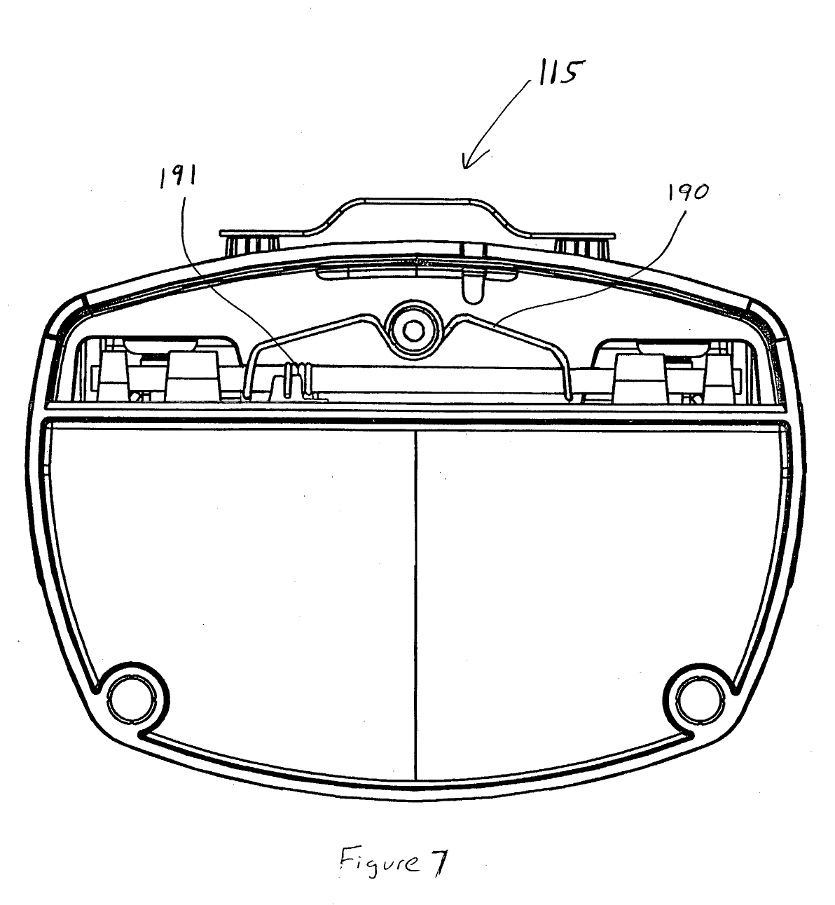

As shown in FIG. 7 an embodiment using multiple torsion springs 190 and 191 allows for alternative opening operations. The first spring 190 allows the plates to be kept together no matter what size cleaning implement is placed within the cleaning implement sanitizer. The second spring 191 slightly resists the opening of the second enclosure 124. As a result a smooth slower retraction of the second enclosure 124 is provided in the opening process.

The cleaning implement sanitizer 15, 115 operates using the steam generated by the moisture within a cleaning implement to sanitize the cleaning implement. The cleaning implement is placed within the cleaning product sanitizer 15, 115 in a damp condition without any debris attached. If the cleaning implement is oversized, it may be folded to fit within the cleaning implement sanitizer 15. The cleaning implement is laid upon the first contact surface 56 of the first heatable plate 54 and the second heatable plate 58 is moved into a position where the cleaning implement sanitizer 15 is closed. In a closed condition the cleaning implement maintains a gap between the first heatable plate 54 and the second heatable plate 58 allowing for the escape of steam.

The functional cycle for the cleaning implement sanitizer consists of three sequential phases. The first phase is a heat up phase. The push button 30 is pressed to start the heat up phase. The pilot light will illuminate to indicate the heating elements are in operation and the heatable plates are being heated. The heating elements are actuated and the heat up phase lasts for approximately three minutes. The thermostat stops the actuation of the heating elements when a factory set temperature is met. This temperature approximately corresponds to the boiling point of moisture in a reference sponge or implement. The next stage is a sanitizing phase which continues until the temperature of the cleaning implement falls below 65.1 C. The heating elements are not actuated during this phase. The next phase is a cool down phase which continues until the temperature of the cleaning implement falls below 49 C. The full sanitizing cycle is approximately 30 minutes. At the end of the sanitizing cycle the cleaning implement may be removed. The cycle may be restarted by re-actuating the push button which also resets the thermostat. The thermostat may need to cool below a factory set temperature before it can be reset however.

Although the device has been shown and described with reference to certain embodiments, minor variations and insubstantial differences in the various combinations of materials and methods of application may occur to those of ordinary skill in the art while remaining within the scope of the invention as claimed and equivalents. Use of the term “or” herein is the inclusive, and not the exclusive use.

1. A device for sanitizing moisture containing cleaning implements comprising:
a first heatable plate;
a second heatable plate;
a hinge for moving said first heatable plate relative to said second heatable plate;
heating elements positioned with respect to said first and second heatable plates to provide heat to said first and second heatable plates respectively; and
whereby during operation of the device steam is generated by the cleaning implement which acts to sanitize the cleaning implement.

2. The device of claim 1 wherein said first and second heatable plates each include a flat rectangular contact surface for contacting a moisture containing cleaning implement.

3. The device of claim 1 wherein said hinge is configured to accommodate cleaning implements of varying thickness.

4. The device of claim 1 including two heating elements wherein a first heating element is located adjacent a side of said first heatable plate opposite a contact surface for engaging the cleaning implement and a second heating element is located adjacent a side of said second heatable plate opposite a contact surface for engaging the cleaning implement.

5. The device of claim 4 wherein said first heating element and said second heating element are electric.

6. The device of claim 1 wherein said first and second heatable plates are operated in a horizontal position.

7. The device of claim 1 wherein said first and second heatable plates are operated in a vertical position.

8. The device of claim 6 wherein said device has, when in a closed position, dimensions not exceeding approximately 30 centimeters in width and not exceeding approximately 30 centimeters in depth.

9. The device of claim 8 wherein said device has, when in a closed position, dimensions of approximately 12.75 centimeters in width and approximately 11.5 centimeters in depth.

10. The device of claim 1, wherein said first and second heatable plates and said heating elements are supported within a device enclosure of a material sufficient to maintain a temperature wherein said device enclosure may be contacted by a user during device operation.

11. The device of claim 7 further including a leg which acts as a base.

12. The device of claim 1 wherein said first heatable plate and said second heatable plate are opaque and prevent the cleaning implement from light exposure when said device is in a closed position.

13. The device of claim 3 wherein said hinge includes barrels and pins and a torsion spring which biases the first heatable plate against the second heatable plate.

14. The device of claim 1 including an pilot lamp which indicates when said heating elements are providing heat to said heatable plates.

15. The device of claim 1 including a thermostat to assist in controlling when said heating elements provide heat to said heatable plates.

16. The device of claim 1 wherein said heatable plates include seats comprised of protrusions upon which said heating elements are supported.

17. A device for sanitizing moisture containing cleaning implements comprising:
a first heatable plate;
a second heatable plate;
a hinge for moving said first heatable plate relative to said second heatable plate and configured to accommodate cleaning implements of varying thickness;
heating elements positioned with respect to said first and second heatable plates to provide heat to said first and second heatable plates respectively;
a thermostat to assist in controlling when said heating elements provide heat to said heatable plates; and
whereby during operation of the device steam is generated by damp cleaning implement which acts to sanitize the cleaning implement.

18. A method of sanitizing cleaning implements including the steps of:
placing a cleaning implement into a sanitizing device having two heatable plates;
heating the heatable plates of the sanitizing device; and
letting the cleaning implement cool within the sanitizing device.

19. The method of claim 18 wherein the heating step is ended when the temperature of the cleaning implement as measured by a thermostat reaches a preset temperature.
